(19) United States
(12) Patent Application Publication
(10) Pub. No.: US 2025/0242507 A1
(43) Pub. Date: Jul. 31, 2025

(54) Folding Knife

(71) Applicant: Yangjiang Zeth Trading Co., Ltd, Yangjiang (CN)

(72) Inventor: Chen Xuejiao, Yangjiang (CN)

(73) Assignee: Yangjiang Zeth Trading Co., Ltd, Yangjiang (CN)

(21) Appl. No.: 18/676,547

(22) Filed: May 29, 2024

(30) Foreign Application Priority Data
Jan. 31, 2024 (CN) 2024202479734

(51) Int. Cl. B26B 1/04

(52) U.S. Cl. CPC B26B 1/04

(57) ABSTRACT

A new type of folding knife includes a handle, a spacer on the inner side of the handle, a flexible backbone on the inner side of the spacer, a blade rotationally connected to the flexible backbone, and a lock clasp. The spacer includes a lock aperture that receives the lock clasp. The lock clasp goes through the lock aperture and slides between locking and unlocking positions in the lock aperture. A lock groove in the blade receives the lock clasp. When in use, the handle is rotated to allow the lock clasp to move under its own weight out of the lock groove in the blade, which allows the blade to open. The handle is rotated again to engage the lock clasp with the lock groove to lock the blade. The folding knife is convenient to use, provides good security, and the overall structure is simpler and easier to assemble.

### FIELD

This invention relates to the technical field of knives, and more particularly relates to a new type of folding knife.

### BACKGROUND

Folding knives have become a common tool in people's daily lives that brings many conveniences. Generally, a folding knife has a knife blade and a handle that are connected on a rotary axis, wherein the knife blade can be rotated and folded up into the knife handle. Conventional folding knives use built-in springs to clamp and lock the knife blade. When used, the knife blade must be gripped and pulled out with the user's fingers, which requires much effort and makes it inconvenient to use. Moreover, after being used for a long time, the elasticity of the springs is insufficient, which makes it difficult to lock, thereby causing greater security risks. Although some folding knives on the market are locked by setting a switch button, they are still inconvenient to use because the button must be pressed by hand. Further, the structure of existing folding knives is complicated and inconvenient to assemble.

### SUMMARY

In response to the above defects of the prior art, the technical problem to be solved by embodiments of the present invention is to provide a new type of folding knife. By adding a lock clasp in a lock hole of a spacer, and a lock groove on the blade that is compatible with the lock clasp, the knife blade can be opened by simply rotating the handle to make the lock clasp detach from the lock groove under the action of its own weight, which releases the blade to move to an open position. To close the blade, the handle is rotated to make the lock clasp engage the lock groove under its own weight. This opening and closing mechanism is convenient and simple to use, has good security, and is easy to assemble.

In order to solve the technical problems associated with prior folding knives, the technical solution is new type of folding knife that includes a handle, a spacer, lock apertures, a blade, and a lock clasp.

The handle comprises a first handle portion and a second handle portion.

The spacer, which is disposed between the first and second handle portions, comprises a first spacer portion and a second spacer portion. The first spacer portion is disposed against an inside surface of the first handle portion, and the second spacer portion is disposed against an inside surface of the second handle portion.

The lock apertures, which are disposed in the first and second spacer portions, each comprises a locking through-hole and an unlocking through-hole. The locking through-hole of the lock aperture in the first spacer portion is aligned with the locking through-hole of the lock aperture in the second spacer portion, and the unlocking through-hole of the lock aperture in the first spacer portion is aligned with the unlocking through-hole of the lock aperture in the second spacer portion.

The blade is disposed between and is rotationally connected to the first and second spacer portions. The blade has a lock groove.

The lock clasp, which is disposed between the first and second handle portions, comprises a lock rod, a first catch portion and a second catch portion. The lock rod is configured to be received and slide within the lock groove of the blade. The first catch portion is disposed at a first end of the lock rod, and the second catch portion is disposed at a second end of the lock rod opposing the first end. The first catch portion is received in the lock aperture in the first spacer portion, and the second catch portion is received in the lock aperture in the second spacer portion. The first catch portion is operable to slide between the locking through-hole and the unlocking through-hole in the lock aperture of the first spacer portion as the lock rod slides with the lock groove of the blade. The second catch portion is operable to slide between the locking through-hole and the unlocking through-hole in the lock aperture of the second spacer portion as the lock rod slides with the lock groove of the blade.

The blade is constrained by the lock rod from rotating with respect to the first and second spacer portions when the first and second catch portions of the lock clasp are received in the locking through-holes of the lock apertures. The blade is operable to rotate with respect to the first and second spacer portions when the first and second catch portions of the lock clasp are received in the unlocking through-holes of the lock apertures.

In some embodiments, the folding knife includes a flexible backbone secured between the first and second spacer portions. The flexible backbone has a flexible end portion that engages the blade in a region that is adjacent to a point at which the blade is rotationally connected to the first and second spacer portions.

In some embodiments, the first and second catch portions are operable to slide in the lock apertures under the weight of the lock clasp.

Some embodiments are directed to a folding knife that comprises a handle, a spacer disposed on an inner surface of the handle, a flexible backbone disposed on an inner surface of the spacer, and a blade disposed on the inner surface of the spacer, wherein the flexible backbone is engaged with the blade. A lock aperture is disposed on the spacer, and at least a portion of a lock clasp is disposed through the lock aperture. A lock groove is disposed on the blade to receive at least a portion of the lock clasp, and at least a portion of the lock clasp slides within the locking groove.

In some embodiments, the lock aperture includes a locking through-hole and unlocking through-hole, wherein the locking through-hole and unlocking through-hole are connected.

In some embodiments, the lock clasp includes a first catch portion, a lock rod, and a second catch portion, wherein the lock rod, the first catch portion, and the second catch portion are integrally connected.

In some embodiments, the spacer comprises a first spacer portion and a second spacer portion, wherein the first spacer portion is connected to the second spacer portion by a connecting pin.

In some embodiments, the flexible backbone includes a connecting pin aperture, wherein the connecting pin passes through the connecting pin aperture.

In some embodiments, the handle includes a first handle portion and a second handle portion, wherein the first handle portion and the second handle portion are disposed on outer surfaces of the first spacer portion and the second spacer portion, respectively.

### BRIEF DESCRIPTION OF THE DRAWINGS

Other embodiments of the invention will become apparent by reference to the detailed description in conjunction with the figures, wherein elements are not to scale so as to more clearly show the details, wherein like reference numbers indicate like elements throughout the several views, and wherein:

FIG. 1 depicts an exploded view of a folding knife according to a preferred embodiment;

FIG. 2 depicts a perspective view of the folding knife in a closed state according to a preferred embodiment;

FIG. 3 depicts a perspective view of the folding knife in an open state according to a preferred embodiment; and

FIG. 4 depicts the internal structure of the folding knife in the closed state according to a preferred embodiment.

Reference numbers in the figures: 1—flexible backbone, 2—blade, 3—lock aperture, 4—lock clasp, 5—lock groove, 6—locking through-hole, 7—unlocking through-hole, 8—first catch portion, 9—lock rod, 10—second catch portion, 12—spacer, 12a—first spacer portion, 12b—second spacer portion, 13—connecting pin, 14—connecting pin aperture, 16—handle, 16a—first handle portion, and 16b—second handle portion.

### DETAILED DESCRIPTION

Preferred embodiments of the disclosure are further described below in connection with the accompanying drawings. It should be noted herein that the description of these embodiments is used to help understand the present disclosure, but does not constitute a limitation of the invention. In addition, the technical features involved in the various embodiments of the disclosure herein may be combined with each other as long as they do not conflict with each other.

In the description herein, it is to be understood that the terms “center”, “longitudinal”, “lateral”, “length”, “width”, “thickness”, “top”, “bottom”, “front”, “back”, “left”, “right”, “vertical”, “horizontal”, “top”, “bottom”, “inside”, “outer”, “clockwise”, “counterclockwise”, “axial”, “radial”, “circumferential” and the like indicate orientation or positional relationships based on those shown in the accompanying drawings, and are intended only to facilitate the description of the embodiments and to simplify the description, and are not intended to indicate or imply that the device or element referred to must have a particular orientation or be constructed or operated in a particular orientation, and therefore should not be construed as a limitation of the present utility model.

In addition, the terms “first” and “second” are used for descriptive purposes only, and are not to be understood as indicating or implying relative importance or the number of technical features indicated. Thus, a feature defined with “first” or “second” may expressly or implicitly include at least one such feature. In the description herein, “plurality” means at least two, such as two, three, etc., unless otherwise explicitly specified.

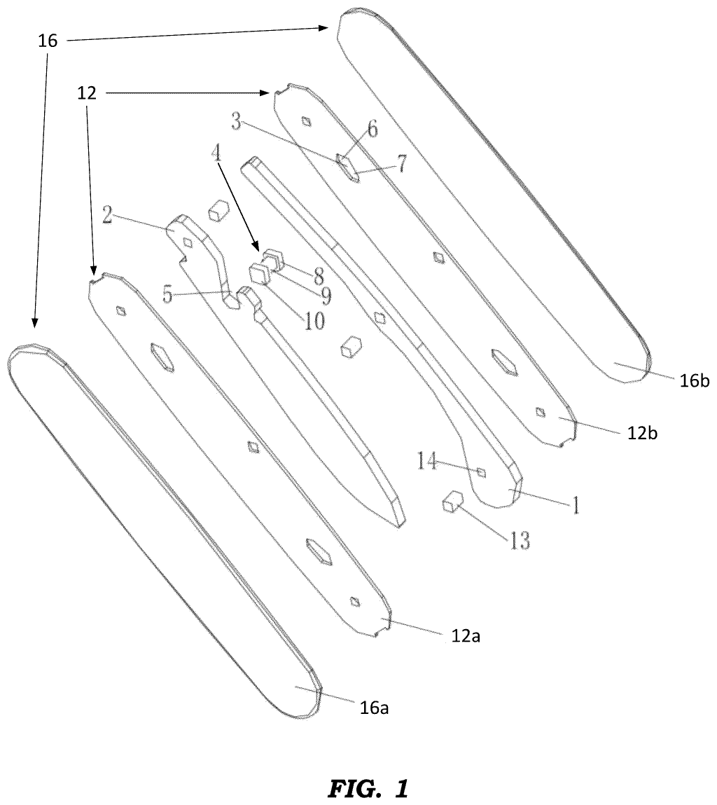

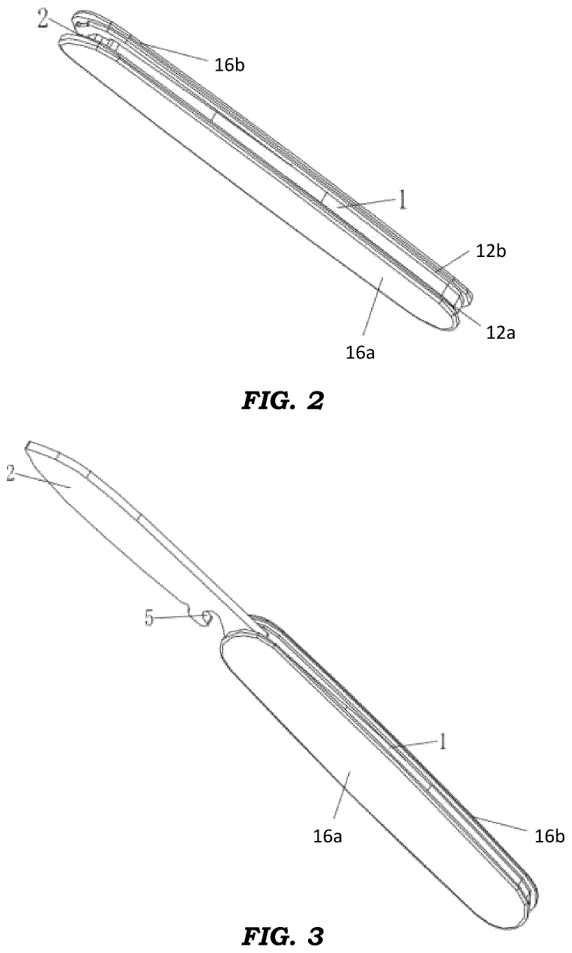

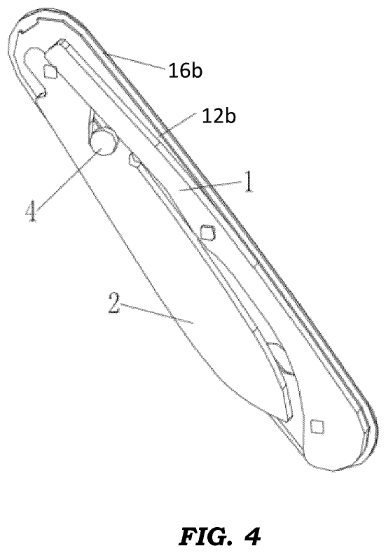

As shown in FIGS. 1-4, preferred embodiments of a folding knife include a handle 16 that comprises first and second handle portions 16a and 16b. A spacer 12 that comprises first and second spacer portions 12a and 12b is disposed inside the handle 16. A flexible backbone 1 is disposed inside the spacer 12, and a blade 2 rotationally engages the flexible backbone 1. It is understood that the handle 16, the spacer 12, the flexible backbone 1, and the blade 2 can be made of stainless steel or aluminum alloy, etc., and the invention is not limited by the choice of materials.

The first spacer portion 12a is connected to the second spacer portion 12b by connecting pins 13. The flexible backbone 1 includes a connecting pin aperture 14, through which the connecting pin 13 passes. The first handle portion 16a and the second handle portion 16b of the handle 16 are provided on the outside of the first spacer portion 12a and the second spacer portion 12b, respectively.

Lock apertures 3 are provided on the spacer portions 12a and 12b. Each of the lock apertures 3 comprises a locking through-hole 6 and an unlocking through-hole 7, wherein the locking through-hole 6 is connected to the unlocking through-hole 7 to form the lock aperture 3.

The folding knife includes a lock clasp 4 that comprises a first catch portion 8, a lock rod 9, and a second catch portion 10. In the preferred embodiment, the lock rod 9 is integrally connected to the first catch portion 8 and the second catch portion 10. The first and second catch portions 8 and 10 of the lock clasp 4 are received in the lock apertures 3. A lock groove 5 is disposed on the blade 2 that receives the lock rod 9 of the lock clasp 4.

It will be appreciated that the first and second catch portions 8 and 10 of the lock clasp 4 can slide freely between the locking through-hole 6 and unlocking through-hole 7 of the lock apertures 3. When the blade 2 is locked, the lock rod 9 of the lock clasp 4 is pressed into the lock groove 5 so as to secure the blade 2. When the blade 2 is to be unlocked, the handle 16 is rotated so as to make the lock clasp 4 disengage from the lock groove 5, which allows the blade 2 to be pulled out for use.

It can be understood that embodiments of the folding knife are reasonably designed with a unique construction, through which the sliding engagement of the first and second catch portions 8 and 10 of the lock clasp 4 in the lock apertures 3 allows for moving the lock rod 9 of the lock clasp 4 with respect to the lock groove 5. When the handle 16 is rotated, the lock clasp 4 slides under its own weight to cause the lock rod 9 to move out of lock groove 5. In this way, the handle 16 can be rotated to unlock and open the blade 2. The handle 16 can then be rotated again to cause the lock clasp 4 to slide under its own weight to the original position in which the lock rod 9 slides into with the lock groove 5 to lock the blade 2 in the closed position. In this manner, preferred embodiments of the folding knife are more convenient to use, provide better security, have an overall structure that is relatively simple, and are easier to assemble.

It will be appreciated that sliding of the lock clasp under its own weight means that it slides under its own weight due to gravity and/or due to centrifugal force caused by a fast rotation of the knife.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A folding knife comprising:
a handle comprising a first handle portion and a second handle portion;
a spacer disposed between the first and second handle portions, the spacer comprising a first spacer portion and a second spacer portion, wherein the first spacer portion is disposed against an inside surface of the first handle portion, and the second spacer portion is disposed against an inside surface of the second handle portion;
lock apertures disposed in the first and second spacer portions, each lock aperture comprising a locking through-hole and an unlocking through-hole, wherein the locking through-hole of the lock aperture in the first spacer portion is aligned with the locking through-hole of the lock aperture in the second spacer portion, and wherein the unlocking through-hole of the lock aperture in the first spacer portion is aligned with the unlocking through-hole of the lock aperture in the second spacer portion;
a blade disposed between and rotationally connected to the first and second spacer portions, the blade having a lock groove;
a lock clasp disposed between the first and second handle portions, the lock clasp comprising:
a lock rod configured to be received and slide within the lock groove of the blade;
a first catch portion disposed at a first end of the lock rod; and
a second catch portion disposed at a second end of the lock rod opposing the first end,
wherein the first catch portion is received in the lock aperture in the first spacer portion, and the second catch portion is received in the lock aperture in the second spacer portion, and
wherein the first catch portion is operable to slide between the locking through-hole and the unlocking through-hole in the lock aperture of the first spacer portion as the lock rod slides with the lock groove of the blade, and
wherein the second catch portion is operable to slide between the locking through-hole and the unlocking through-hole in the lock aperture of the second spacer portion as the lock rod slides with the lock groove of the blade,
wherein the blade is constrained by the lock rod from rotating with respect to the first and second spacer portions when the first and second catch portions of the lock clasp are received in the locking through-holes of the lock apertures, and
wherein the blade is operable to rotate with respect to the first and second spacer portions when the first and second catch portions of the lock clasp are received in the unlocking through-holes of the lock apertures.

2. The folding knife of claim 1 further comprising a flexible backbone secured between the first and second spacer portions, the flexible backbone having a flexible end portion that engages the blade in a region that is adjacent to a point at which the blade is rotationally connected to the first and second spacer portions.

3. The folding knife of claim 1 wherein the lock clasp has a weight, and the first and second catch portions are operable to slide in the lock apertures under the weight of the lock clasp.

4. A folding knife comprising a handle, a spacer disposed on an inner surface of the handle, a flexible backbone disposed on an inner surface of the spacer, and a blade disposed on the inner surface of the spacer, wherein the flexible backbone is engaged with the blade, characterized in that there is a lock aperture on the spacer, and at least a portion of a lock clasp is disposed through the lock aperture, wherein a lock groove is disposed on the blade to receive at least a portion of the lock clasp, and at least a portion of the lock clasp slides within the locking groove.

5. The folding knife according to claim 4, characterized in that the lock aperture includes a locking through-hole and unlocking through-hole, wherein the locking through-hole and unlocking through-hole are connected.

6. The folding knife according to claim 4, characterized in that the lock clasp includes a first catch portion, a lock rod, and a second catch portion, wherein the lock rod, the first catch portion, and the second catch portion are integrally connected.

7. The folding knife according to claim 4, characterized in that the spacer comprises a first spacer portion and a second spacer portion, wherein the first spacer portion is connected to the second spacer portion by a connecting pin.

8. The folding knife according to claim 7, characterized in that the flexible backbone includes a connecting pin aperture, wherein the connecting pin passes through the connecting pin aperture.

9. The folding knife according to claim 7, characterized in that the handle includes a first handle portion and a second handle portion, wherein the first handle portion and the second handle portion are disposed on outer surfaces of the first spacer portion and the second spacer portion, respectively.
